(19) United States
(12) Patent Application Publication
(10) Pub. No.: US 2005/0087128 A1
(43) Pub. Date: Apr. 28, 2005

(54) Spray gun

(76) Inventor: Zijad Jakupovic, Frankfurt (DE)

Correspondence Address: Zlata Djurdjevic, 6147 52nd Ave N., Kenneth City, FL, 33709, US

(21) Appl. No.: 10/890,898

(22) Filed: Jan. 3, 2005

(30) Foreign Application Priority Data
Nov. 2, 2003 (DE) 13780336
Apr. 25, 2003 (DE) 103 05 385.9-51

(51) Int. Cl. B05C 5/00; B05B 7/00; B05C 15/00

(52) U.S. Cl. 118/300; 239/525; 239/526

(57) ABSTRACT

The spray gun or airbrush gun was first patented in 1893 by Charles Burdick. The newly constructed and built spray gun is built similar to that first model. The spray gun (Illustration 5, Illustration 6) consists of three units—air valve, trigger mechanism and fluid body—which have been fitted inside the gun body (12 mm diameter and 13 cm length). The axial motion of the trigger mechanism is 8 mm. The trigger mechanism can be pulled back with a ball-shaped lever and the air valve opens. The compressed air then streams through the air inlet tube into the air outlet tube. The air outlet tube has been put into the fluid reservoir, and the over-pressure created in this reservoir pushes the fluid to the ground and makes it go through the tube and into the tip.

The idea of such a spray gun does not sound very revolutionary because many tools for the application of viscid substances do already exist. In former times just as today brushes and spatuals are used for working with viscid substances to a desired spot, from where it can be spread using brusjes and spatulas. However, these tools are tough rough for fine working and mechanically impactical. A smaller spray gun would be easier to handle and make many kinds of work much easier. Especially in areas where the the optical impression is of great importance—p. ex. dyeing hair ata hairdresser—it would be of great advantage since the customer always prefers being served using the most sophisticated euipment. For dying hair, hairdressers use viscid colour-components, which are mixed inside a small pot and are then spread an inch above the roots of the hair by using a flat brush. Aspray gun for viscid substances would make that kind of work much easier and since the best hairdressers are already using airbrush guns for the application of makeup, the use of another spray gun would not be extrordianry at all.

The described spary gun could also be used in the area of art, crafts, and chemistry.

### TECHNICAL SOLUTION TO THE PROBLEM

The body of the newly constructed and built spray gun is not dtermined by the air inlet fitting but is shaped functionally so as to permit a natural working position, easy repair and easy handling of the spray gun. The spray gun consists of three units which have been fitted into the interior of the spray gun body (12 mm diameter). As a consequence the production of the spray gun is simplified becuase the individually built units have been put together and been brazed and there is no subsewuent work to be done.
Unit 1, Illustration 1: Spray gun body (1), fluid reservoir (2), tip (3), cap with passageway (4), rubber packing (5), air inlet fitting with knob (6), ornamental screw and entry to blocking valve (7), rubber packing (8), rubber packing (9), rubber tube (10), tube for colouring substance (11).
Unit 2, Illustration 2: Air valve consisting of Air valve body (1), air inlet tube (2), air outlet tube (3), passageway for trigger machanism (4), passageway for blocking valve (5), blocking valve piston with rubber packing and needle (6), pull back spring (7), blocking valve guide rail (8).
Unit 3, Illustration 3: Trigger machanism consisting of: (guide) groove (1), borehole for lever (2), lever (3), pull back spring (4), device for closing the valve and opening the blocking valve (5).
Unit 4, Illustration 4: Fluid body consisting of Front passageway (1), (guide) groove for trigger mechanism (2), connection to the paint reservoir (3), borehole for air outlet tube (4).

Illustration of the complete spray gun: Illustration 1, Illustration 5.

### OPERATION OF THE SPRAY GUN

Unit 2, the air valve (Illustration 2) and unit 4, the fluid body (Illustration 4) have been brazed to the spray gun body (Illustration 1, (1)) while unit 3, the trigger mechanism (Illustration 3), is not connected to any other unit. It slides through interconnected tubes fulfills several functions. The axial motion of the complete trigger mechanism (Illustration 3) is 8 mm. The trigger mechanism (Illustration 3) is being pulled back with the ball-shaped lever (Illustration 3, (3)) from its forward resting-position against the pull back spring (Illustration 2, (7); Illustration 3, (4)).

The lever (Illustration 3, (3)) also serves to block the front passageway for the trigger mechanism (Illustration 2, (4)) and simultaneously opens the passageway for the trigger mechanism (Illustration 2, (5)) by pushing the blocking valve piston (Illustration 2, (6)) against the pull back spring (Illustration 2, (7)). Air stream from the air inlet tube (Illustration 2, (2)) into the air outlet tube (Illustration 2, (3)) and into the fluid reservoir (Illustration 1, (2)). The over-pressure created thereby in the fluid reservoir (Illustration 1, (2)) makes the fluid flow into the tube for coloring substance (Illustration 1, (11)) and further into the fluid body (Illustration 4 ). From there it flows into the tip (Illustration 1, (3)) which is connected to the spray gun body (Illustration 1, (1)) by the cap (Illustration 1, (4)). When pressure on the lever (Illustration 3, (3)) is released, the trigger mechanism (Illustration 3) moves back to its resting position and the over-pressure in the fluid reservoir (Illustration 1, (2)) is leveled out because the pressurized air can evaporate in a certain area (Illustration 1, (5)) when the trigger mechanism (Illustration 3) is in its forward resting position.

The spray gun is easy to handle and the applicant can move the air inlet fitting to the rear end of the spray gun (Illustration 1, (7)). In that case, the air inlet fitting (Illustration 1, (6)) has to be sealed with the ornamental screw (Illustration 1, (7)).

Spray gun for the application of viscid substances with a gun body (Illustration 1, (1)), an air inlet fitting (Illustration 1, (6)) which can be connected to an air supply and a cap (Illustration 1, (4)) at the front end holding a tip (Illustration 1, (3)), a lever (Illustration 3, (3)) and a fluid reservoir (Illustration 1, (2)). The spray gun consists of three units which have been fitted into the gun body. Each unit depends on the other units and fulfills a certain function. The air valve piston (Illustration 2) regulates the air inlet into the fluid reservoir (Illustration 1, (2)), the trigger mechanism (Illustration 3) opens the air valve piston (Illustration 2, (6)) and simultaneously closes the front passageway for the trigger mechanism (Illustration 2, (4)). The fluid body (Illustration 4) with the front passageway (Illustration 4, (1)) allows the passage of viscid substances from the fluid reservoir (Illustration 1, (2)) into the tip (Illustration 1, (3)) via the tube (Illustration 1, (11)) in the fluid reservoir (Illustration 1, (2)) and the fluid body (Illustration 4, (2)) serves as a guide for the trigger mechanism (Illustration 3).

1. I claim that the newly constructed and built spray gun, used for the application of liquid substances, will make the individual's task of applying the liquid substance on any surface much simpler and cleaner. This is because the new spray gun is shaped functionally in order to allow a natural working position, as well as easy repair and easy handling.
